(19) United States
(12) Patent Application Publication
(10) Pub. No.: US 2004/0118161 A1
(43) Pub. Date: Jun. 24, 2004

(54) Fusing acceleration and improved process control

(76) Inventors: Horst Loch, Niedernhausen (DE); Wolfgang Muschick, Budenheim (DE); Petra Illing Zimmermann, Nierstein/Schwabsburg (DE); Stefan Schmitt, Stadecken-Elsheim (DE)

Correspondence Address: John F Hoffman, Baker & Daniels, Suite 800, 111 East Wayne Street, Fort Wayne, IN, 46802, US

(21) Appl. No.: 10/473,523

(22) PCT Filed: Mar. 28, 2002
(86) PCT No.: PCT/EP02/03532

(30) Foreign Application Priority Data
Mar. 31, 2001 (DE) 101162936

(51) Int. Cl. C03B 5/16; C03B 5/193

(52) U.S. Cl. 65/134.5; 65/135.2; 65/346; 65/347

(57) ABSTRACT

The invention relates to a method for producing and/or preparing molten glass. The invention is characterised by the following: the molten glass flows in a container in a principal flow direction, the level of the molten glass being at a specific height above the base surface of the container; streams of a free-flowing medium are introduced into the molten glass in such way that said glass flows in spiral paths and that the axes of the spirals run parallel or approximately parallel to the principal flow direction; neighbouring inlet points of the streams are separated by a mutual distance, (viewed from the principal flow direction), of at least 0.5 times the height of the molten glass level.

The invention relates to a process and a device for the manufacture and/or preparation of molten glass.

The essential features of a glass manufacturing process are known from many prior-art documents. At first, molten glass is produced in a tank or crucible from a batch or from glass shards. The molten glass is then purified. The purification step frequently occurs to a large extent as early as in the fusing tank itself. In general, however, a purification container—tank or crucible—is connected downstream. Lines are connected which can be either open chutes or closed pipelines. Settling containers and mixing tanks can be connected in-line or downstream. Reference is made to the document DE 199 38 786 A1 (only as an example).

The fusing of glass batches can be subdivided into two main phases. In the so-called silicate forming phase, certain components of the glass batch react starting at a certain temperature, producing easily fusible primary molten glass. Components that have difficulty fusing such as sand form silicates with this primary molten glass.

In a second phase, the so-called raw molten glass develops. Here, the silicates act as solubilizing agents of the remaining components.

The time duration of these chemical reactions is determined especially by the kinetics of the heat transfer. In the batch and in the molten glass, heat is introduced, for example, by heating from the upper space of the furnace or by direct electric heating using electrodes. As seen in a plane perpendicular to the axis, a revolving flow forms in the resulting molten glass, and specifically, this flow forms in the manner of a roll with a horizontal axis. This flow is hereinafter referred to as the “roll”. The roll itself has a favorable action. It conveys volume elements of the molten glass that have already been greatly heated back under the batch and thus makes easier its continuous fusing from below. The undissolved components are then dissolved in the raw molten glass. Only after the complete conclusion of this phase can the purification be successfully ended. It is important that all bubbles are removed. Even for special glasses, it is extremely undesirable for them to contain bubbles. The more rapidly the raw molten glass progresses, the higher is the quality and the yield of the tank. In spite of this, the energy input may not exceed a certain quantity during fusing of a batch or of glass shards. Otherwise, this would lead to a premature activation of purification agents, so that they would no longer be available during the actual purification phase.

The aforementioned flow rolls are primarily induced by thermal differences. It is known from the prior-art that the intensity of these rolls can be influenced by blowing in gas. In this process, for example, gas nozzles are arranged in a row on the bottom of a fusing tank. The row runs perpendicularly to the principal flow direction of the molten glass. To a certain extent, a presence of gas streams is generated. As gases, for example, air or oxygen is used. The nozzles are created in such a way that relatively large bubbles occur, which rapidly climb up to the surface, and thus do not remain in the molten glass.

The purpose of the invention is to improve the aforementioned process of the fusing of molten glass. In particular, the process efficiency and the process control should be improved.

This purpose is achieved by the characteristics of the independent claims.

The inventors recognized the following: When generating a thermally induced convection in the form of rolls, volume elements of the molten glass, which already have experienced sufficient heat treatment, get to the surface of the molten bath, where they are again exposed to a heat treatment. They are thus rolled over uselessly. Other volume elements, on the other hand, do not get to the surface over longer time periods and are thus not subject to the heating action, although it would be necessary. The time of the stay in the tank involved must thus be measured in such a way that the heating action also includes these latter mentioned volume elements.

An additional disadvantage of the principle of the “thermally induced roll” consists in the following: If a certain parameter such as the temperature changes slightly at a certain position, then this can cause considerable effects at another position because of the convection in the tank. A change at one position thus makes it difficult to foresee changes at another position. A certain volume element experiences large temperature differences in its flow path which can not be adjusted as desired. The system is thus extremely “non-linear”.

An additional disadvantage of the conventional system lies in the poor energy balance. The aforementioned, system-related, large time duration of the treatment means that also a lot of heat is lost due to losses at the walls.

The inventors have pursued a fully new approach. They generate the necessary convection for the most part in that they introduce media streams into the molten glass, and that they arrange the streams in such a manner that in the molten glass a spiral flow forms having its axis in the process direction and slowly migrating to the outlet. The spiral flow is primarily generated by the mechanical impulse of the blow nozzles, whereas in the state-of-the-art, it is especially the temperature gradients that generate the aforementioned rolls. Thus, a decoupling is performed between the energy input that is itself necessary in the form of heat on the one hand, and the generation of velocity gradients on the other hand.

DE 43 13 217 C1 involves the purification of molten glass. In this process as well, glass bubbles are introduced into the fused molten glass using bubbling nozzles. However, this only involves the purification of the molten glass, whereas in the present case, it involves the optimization of the glass fusing.

In U.S. Pat. No. 2,261,034, the construction of a special blow nozzle to introduce gases into the molten glass is described. The use of the blow nozzle functions for purification of the molten glass and not the actual fusing process.

In U.S. Pat. No. 2,909,005, the use of floor blow nozzles in the area of the fusing tank in order to generate convection flows is described. In the document, the blow nozzles are distributed in the most diverse arrangements over the floor of the fusing tank, among other things, even in the direction parallel to the longitudinal axis of the tank. However, what is not described is which arrangements lead to especially advantageous results. Furthermore, it is not described which separation distances the blow nozzles must/may have from each other and in relation to the glass level, in order to obtain especially advantageous results. The arrangements described in the figures lead to extremely turbulent flows, in which the individual blow nozzle flows clearly influence each other because of the small separation distances and thus must lead to negative results.

Also, no embodiments are described relating to the geometry of the fusing systems and the installation method of the blow nozzles which depends on it. A minimum necessary separation distance from the walls of the glass fusing tank is also not mentioned.

In FR 1 303 854, the generation of special convection flows in glass fusing tanks using electrodes is described, and specifically, two electrode rows.

No embodiments are described relating to the geometry of the fusing systems and the installation method of the electrodes. A minimum necessary separation distance from the walls of the glass fusing tank is also not mentioned.

In U.S. Pat. No. 3,305,340, the use of combined electrode blow nozzles in one glass fusing tank is described. The electrode blow nozzles are arranged along the side walls in the longitudinal direction and are simultaneously used to heat the molten glass and to introduce inert gas.

By the arrangement in the wall region, a flow from the wall to the middle of the glass fusing tank is generated.

As is generally known, the arrangement of blow nozzles in direct proximity to the walls of the glass fusing tanks leads to considerably higher corrosion of the wall material and thus to the shortening of the lifetime of the fusing tank.

Furthermore, by the arrangement of the blow nozzles in the edge area, the optimal spiral-shaped flows can not be generated.

In U.S. Pat. No. 3,268,320, different possibilities for generating flows in glass fusing tanks are described. Among other things, the use of blow nozzles, arranged along the middle axis of the tank in the longitudinal direction in order to generate a spiral-shaped flow is described.

However, it is not described which separation distances the blow nozzles must/may have from each other and in relation to the glass level, in order to obtain especially advantageous results.

Also, no embodiments are described relating to the geometry of the fusing systems and the installation method of the blow nozzles depending on it. A minimum necessary separation distance from the walls of the glass fusing tank is also not mentioned.

The arrangement of two or more rows of blow nozzles parallel to the longitudinal axis of the tank is also not described.

In FR 2 787 784, different processes for generating spiral-shaped flows in glass fusing tanks are described. Among other things, the use of blow nozzles in the middle of the tank width is described in order to form one or more spiral-shaped flows.

An arrangement of several blow nozzles along the longitudinal axis of the tank and/or several such longitudinal rows is not described.

Also not described is what separation distances the blow nozzles must/may have from one another in relation to the glass level, in order to obtain especially advantageous results.

In U.S. Pat. No. 2,909,005, the use of floor blow nozzles in the area of the fusing tank in order to generate convection flows is described. The blow nozzles are distributed in various arrangements above the floor of the fusing tank, among other things, also in the direction parallel to the longitudinal axis of the tank. However, which arrangements lead to especially advantageous results is not described. Furthermore, which separation distances the blow nozzles must/may have from each other and in relation to the glass level, in order to obtain especially advantageous results, is not described. The arrangements described in the figures lead to extremely turbulent flows, in which the individual blow nozzle flows clearly influence each other because of the small separation distances from each other and thus must lead to negative results.

Also, no embodiments are described relating to the geometry of the fusing systems and the installation method of the blow nozzles depending on it. A minimum necessary separation distance from the walls of the glass fusing tank is also not mentioned.

In FR 2 773 555, the use of under-glass burners in a glass fusing tank is described. The under-glass burners are arranged along the longitudinal axis of the tank. The underglass burners function for the heating and/or support of the heating of the molten glass, but not in order to generate spiral-shaped flows along the longitudinal axis of the tank. For their operation, considerable quantities of gas are necessary.

They are greater than the quantities of gas usually used in order to operate blow nozzles. By the use of under-glass burners, a combustion zone is generated in the molten glass. This leads to convection flows, however, which are clearly greater than would be advantageous for the generation of spiral-shaped flows in the longitudinal axis of the tank. By the use of under-glass burners, an extremely turbulent flow results, which is in no way identical to the spiral-shaped flow described in the invention.

Also, no embodiments are described relating to the geometry of the fusing systems and the installation method of the under-glass burners depending on it. A minimum necessary separation distance from the walls of the glass fusing tank is also not mentioned.

Important or functional characteristics of the invention are given in the following:

Arrangement of several blow nozzles in two or more rows parallel to the longitudinal axis of the tank in order to produce spiral-shaped flows.

Minimum separation distance of the blow nozzles from the outer wall of 0.4 m and/or half glass level in order to avoid increased corrosion of the fireproof walls of the glass fusing tank. If the distance between blow nozzles and the wall is chosen to be smaller, then an increased corrosion of the wall occurs due to the flow rolls produced by the blow nozzles, since the forward flows produced in the area of the blow nozzles are impressed almost with the same strength in the area of the wall as the backwards flows. When there is a sufficiently large distance between blow nozzles and the wall, this effect is avoided since the radius of the flow rolls formed is then smaller than the separation distance between blow nozzles and the wall. The backwards flows induced by the blow nozzles then occur at a sufficiently large separation distance from the wall. The maximum separation distance of the blow nozzles from the wall should not be over 1.3 times the glass level, since otherwise the positive effect of the blow nozzles on the flow rolls is impaired by flows shooting through at the boundary. The defined spiral-shaped movement of the glass flow is also weakened by wall separation distances that are too wide.

Separation distance of the blow nozzles from each other of at least 0.8 times the glass height, but at maximum 1.5 times the glass height. Contrary to the calculations using mathematical simulations, according to which especially narrow separation distances of the blow nozzles should lead to advantageous results, the necessity surprisingly revealed in the real experiments was for a defined separation distance between the individual blow nozzles. At separations distances of the blow nozzles from each other that are too close, large effects occur on the flows due to the gas introduced via the blow nozzles and in this way, undefined flows occur which in the end lead to bypass flows and thus to a negative effect (significantly reduced minimum time of stay). Important for a good and homogenous glass quality, however, are larger periods of inactivity, in order to ensure that the glass, which is carried out by the fastest flow and has the shortest time of stay in the fusing assembly, has a good quality (no bubbles, little stones, crystals, reams, remnants, etc.). When the separation distances of the blow nozzles from each other are too wide, the flows produced locally by the blow nozzles are not sufficient to generate an overall spiral-shaped flow along the longitudinal axis of the tank; this results in the formation of blow nozzle rolls that are isolated from each other which can no longer have an effect on the total flow or have less effect. The period of inactivity decreases again, and the molten remnants increase.

Depending on the geometry of the glass fusing tank, varying numbers of blow nozzles and/or rows of blow nozzles are especially advantageous. Taking into consideration the aforementioned conditions with regard to the distance of the blow nozzles from each other and from the outer walls, depending on the glass height and width of the glass fusing tank, optimal numbers of blow nozzle rows are produced parallel to the longitudinal axis of the tank. Thus for a tank width of 8 m and a glass height of 1.4 m, the arrangement of 5 to 7 blow nozzle rows is an optimal arrangement to obtain the effect according to the invention.

As is generally known from the prior-art, by introducing gas into the molten glass, the redox condition of the molten glass can be manipulated. Thus, for example, the introduction of oxygen or air leads to oxidation, the introduction of nitrogen or helium leads to the reduction of the molten glass. This is especially important when setting the desired color of the glass. It could be observed that by O₂-bubbling, the porosity of the molten glass can be influenced most favorably. Specifically, after the bubbling zone, you have a larger number of bubbles—especially since satellite bubbles shoot in due to the large bubbles popping. The small bubbles, however, predominately contain oxygen and are reabsorbed again within a short time. A similar process be observed in helium bubbling. In contrast to oxygen, helium is probably not chemically dissolved in glass, but physically diffuses in the glass matrix. Depending on the type of glass, water can even be used as bubbling gas, since it also can be dissolved again very well in the glass matrix. All other bubbling gases—such as air, N₂, CO₂, Ar, etc.—are disadvantageous for the bubble quality, since the elimination of residual bubbles can only be done via physical rising of the bubble and no resorption of the gases occurs.

Furthermore, considerable differences exist in the method of action of the gases brought into the molten glass and the behavior of the gases in the subsequent progression of the molten glass and purification process. Thus, for oxidizing molten glass, the use of oxygen and for reducing molten glass, the use of helium are especially recommended.

The advantages of the invention can be summarized as follows:

The individual molten particle frequently gets onto the heat impinged surface due to the nature of the flow that is in the shape of a spiral progressing to the outlet. In the process, there is a high statistical probability

that all molten particles are treated in approximately the same manner.

The thermal mixing is optimal.

The mechanical mixing is optimal.

The temperature is relatively homogenous in each cross-sectional plane to the principal direction of flow. This means that the temperature can be influenced locally in a limited manner without it having global effects at those positions at which it would be undesired.

In practice, the following possibilities result:

either the throughput increases—while the quality stays the same and with the same dimensions of the container—

or

the quality can be increased for equal dimensions of the container and for equal throughput

or

the dimensions can be reduced with equal quality and equal throughput.

The energy balance is favorable.

The invention is explained using the drawings. In them, the following is shown in detail:

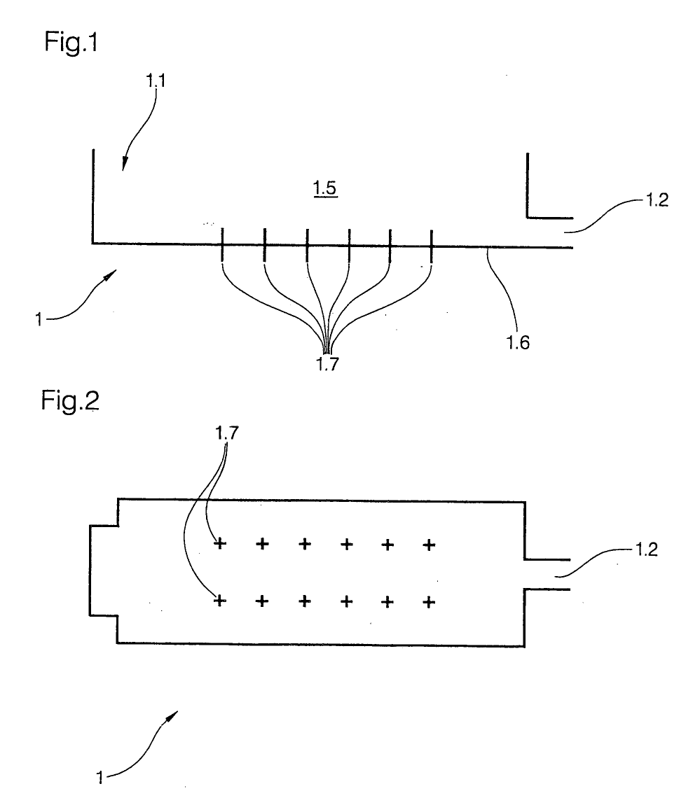

FIG. 1 shows a greatly schematized elevation diagram of a fusing tank with nozzles.

FIG. 2 shows the object of FIG. 1 in overhead view.

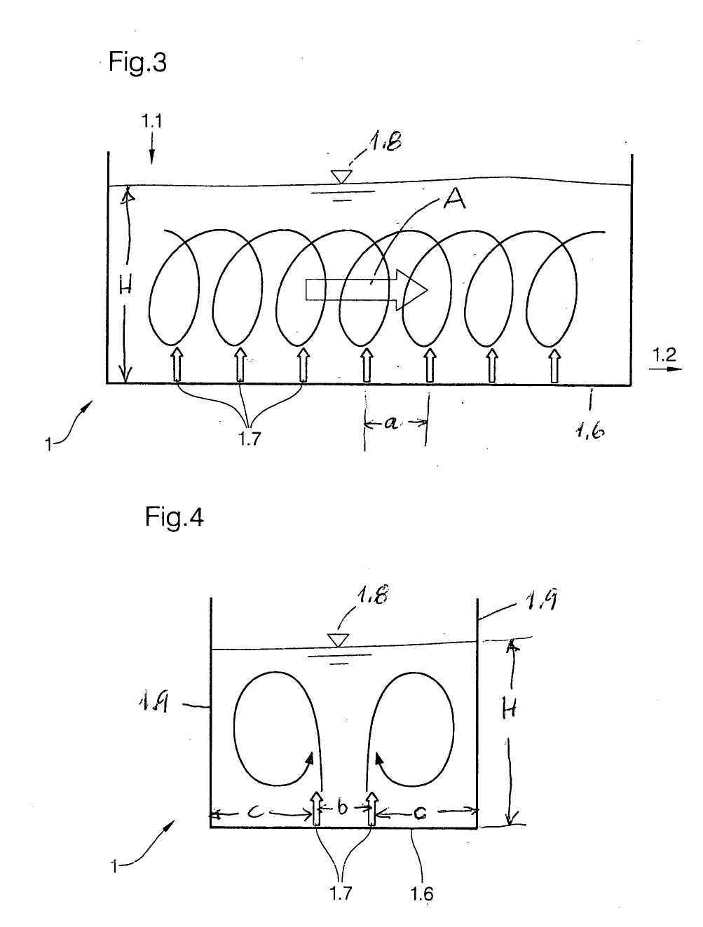

FIG. 3 shows, in a schematized elevation view, a fusing tank in a longitudinal section showing the flow.

FIG. 4 shows the object of FIG. 3 in a cross-section.

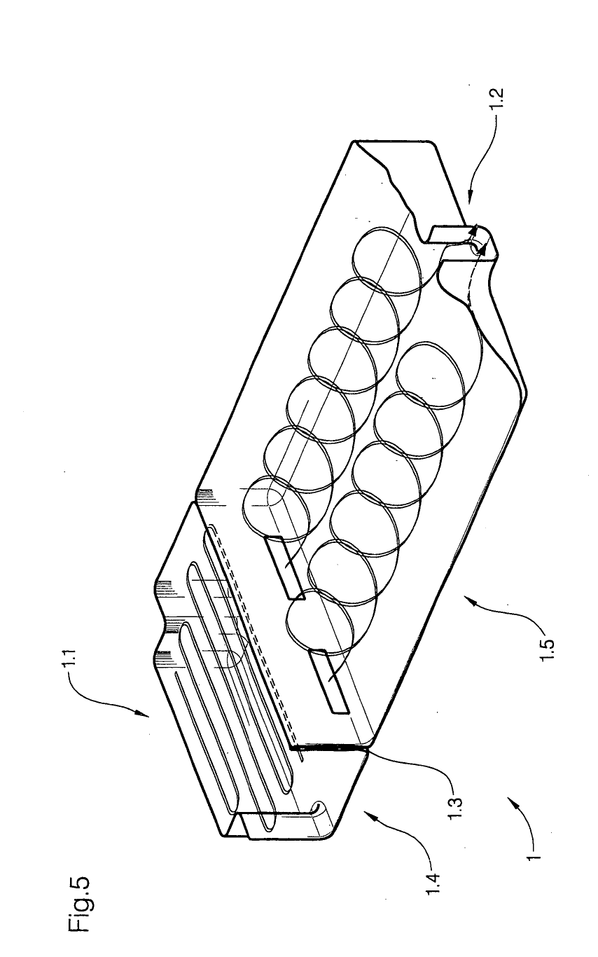

FIG. 5 shows a typical assembly of a fusing tank in perspective diagram with flow filaments, produced from a mathematical simulation.

Into the fusing tank 1 shown in FIGS. 1 and 2, a batch or shards are fed in the area of an inlet 1.1. The molten glass is conducted further through an outlet 1.2 to the subsequent process steps.

In the floor 1.6 of the fusing tank 1, nozzles 1.7 (not shown here) according to the invention are arranged which are directed towards the principal fusing space 1.5, and through which a medium such as air is blown into the molten glass. The nozzles are arranged in two rows. Each row runs in the process direction, i.e. in the direction in which the molten glass is moving in the shape of a spiral flow, and specifically, from the inlet 1.1 to the outlet 1.2.

The spiral flow can be recognized in FIGS. 3 and 4. Also again here, the nozzles 1.7 can be seen in the floor 1.6 of the fusing tank 1.

In FIG. 3, the principal flow direction is shown by the arrow A.

The glass height H is shown. This is the dimension between the floor 1.6 of the tank 1 (molten glass-contacted floor surface) and the level 1.8 of the molten glass. According to the invention, the mutual distance a of the two adjacent blow nozzles should be—in the principal flow direction—according to the invention at least 0.5 times the glass level, or even better at least 0.8 times. The separation distance should be smaller, however, than 1.2 times the glass level. It should in any case be smaller than 1.5 times the glass level.

FIG. 4 shows the ratios in cross-section, and also the dimensions that are relevant here. In it, the mutual distance b between the two rows of nozzles 1.7 can be seen, and in addition the distance c between a nozzle 1.7 of a row and the next adjacent longitudinal side wall 1.9.

For the dimension b, the data for the dimension a apply approximately.

For the dimension c, it applies that it should be approximately equal to half of the glass level H.

The fusing tank 1 shown in FIG. 5 has an inlet 1.1 and an outlet 1.2. The tank 1 has an additional bridge wall 1.3 with two passages on the floor, which separates the so-called raw molten glass from the principal fusing space 1.5. The principal fusing space 1.5 has two rows of nozzles allocated to it (not shown here). Each nozzle row contains six nozzles which produce corresponding spiral whirls that can be seen here.

### Reference Indicator List

1 Fusing tank

1.1 Intake of the fusing tank 1 (doghouse area)

1.2 Outlet of the fusing tank 1

1.3 Bridge wall

1.4 Raw molten glass

1.5 [illegible] fusing space

1.6 Floor of the fusing tank

1.7 Nozzles

1.8 Molten glass level

1.9 Longitudinal side wall

A Principal flow direction

H Glass level

a Mutual nozzle separation distance in the principal flow direction

b Mutual nozzle separation distance in the crosswise direction

c Separation distance nozzle—wall

1. Process for manufacturing and/or preparing molten glass, with the following characteristics:
1.1 the molten glass flows in a container (1) in a principal flow direction (A), while the level of the molten glass is at a specific height H above the floor surface (1.6) of the container (1);
1.2 streams of a free-flowing medium are introduced into the molten glass in such a way that the molten glass flows in spiral paths and that the axes of the spirals are parallel or approximately parallel to the principal flow direction (A);
1.3 adjacent inlet points of the streams are separated—as seen in the principal flow direction (A)—by a mutual distance of at least 0.5 times the height of the glass level H.

2. Process according to claim 1, characterized in that the mutual separation distance between adjacent inlet points of the streams is at least 0.8 times the height of the glass level H.

3. Process according to claim 1 or 2, characterized in that the mutual separation distance between adjacent inlet points of the streams in the flow direction is at most 1.5 times the glass level H.

4. Process according to one of the claims 1 to 3, characterized in that as a medium, a gas such as air or oxygen or nitrogen or helium is used.

5. Process according to one of the claims 1 to 3, characterized in that a liquid is used as the medium.

6. Process according to claim 5, characterized in that the liquid is molten glass.

7. Process according to claim 6, characterized in that the molten glass used for the steams is drawn off from the molten bath.

8. Process according to one of the claims 1 to 7, characterized in that the medium streams are introduced in parallel to the principal flow direction (A) into the molten glass.

9. Process according to one of the claims 1 to 8, characterized in that the medium streams are applied in pulses.

10. Device for manufacturing and/or treating molten glass:
10.1 with a container (1) that has an outlet to which the molten glass flows along a main flow direction (A);
10.2 with a number of nozzles (1.7) which are designed and arranged in such a way that the flow of the molten glass has a spiral progression, whereby the axes of the spirals run parallel or approximately parallel to the principal flow direction (A);
10.3 with medium sources that are under pressure and are connected to the nozzles (1.7);
10.4 the nozzles that are adjacent to each other (1.7) have—as seen in the principal flow direction (A)—a mutual distance which is at least 0.5 times the glass level H.

11. Device according to claim 10, characterized in that nozzles that are adjacent to each other (1.7) have—as seen in the principal flow direction (A)—a mutual separation distance which is at least 0.8 times the glass level H.

12. Device according to claim 10 or 11, characterized in that nozzles that are adjacent to each other (1.7) have—as seen in the principal flow direction (A)—a mutual separation distance which is at least 1.5 times the glass level H.

13. Device according to one of the claims 9 to 12, characterized in that the container (1) is a fusing tank.

14. Device according to claim 13, characterized in that the container (1) is an open or a closed chute.

15. Device according to one of the claims 10 to 14, characterized in that two or more rows of blow nozzles (1.7) are provided.

16. Device according to one of the claims 10 to 15, characterized in that the separation distance c between a longitudinal side wall (1.9) and a nozzle (1.7) of the adjacent nozzle row lies on the order of magnitude of half of the glass level (H).
